(19) United States
(12) Patent Application Publication
(10) Pub. No.: US 2007/0049355 A1
(43) Pub. Date: Mar. 1, 2007

(54) Portable wireless keyboard

(76) Inventor: Wen-An Wu, Danshui Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/209,830

(22) Filed: Aug. 24, 2005

(51) Int. Cl. H04M 1/00

(52) U.S. Cl. 455/575.1

(57) ABSTRACT

A portable wireless keyboard is disclosed. The portable wireless keyboard of the present invention may be used with all types of cell phones and PDAs currently available on the market. A detachable rack is disposed inside the keyboard, and a cell phone or a PDA may be placed on the rack. In addition, the keyboard comprises two units, which allow the keyboard to be folded up when it is not used so that a user may carry the keyboard with him. Whence, the keyboard's design is of practical application and convenience.

### BACKGROUND OF THE INVENTION

1. Field of the Invention

The invention generally relates to a portable wireless keyboard. More particularly, the invention relates to a portable wireless keyboard that may be used with all types of cell phones and PDAs currently available on the market.

2. Description of the Prior Art

As of now, a keyboard used for a cell phone or a PDA is provided with a particular kind of connector and is used exclusively for a cell phone or a PDA of a particular brand; in addition, the size of such keyboard is either too small or too big, making it difficult for a user to use or to carry it. Recently, with the availability of the wireless technology, the problem of connector is solved; however, each wireless keyboard currently available on the market is designed to be used exclusively with a cell phone or PDA of a certain kind or model. Hence, if a person changes his cell phone or PDA, he needs to buy another keyboard, which costs money; hence, such wireless keyboard needs to be improved.

### SUMMARY OF THE INVENTION

The object of the present invention is to provide a portable wireless keyboard that may be used with all types of cell phones and PDAs currently available on the market.

A detachable rack is disposed inside the keyboard, and a cell phone or a PDA may be placed on the rack. Also, a driver is provided. After the driver is installed and activated, a wireless connection will be established between a cell phone or PDA and the keyboard. Also, the driver allows a user to set speedy switching functions. In addition, when the battery is low on electricity, an LED will flash to remind the user to replace the battery.

In addition, the keyboard comprises two units, which allow the keyboard to be folded up when it is not used so that a user may carry the keyboard with him. Whence, the keyboard's design is of practical application and convenience.

### BRIEF DESCRIPTION OF THE DRAWINGS

The drawings disclose an illustrative embodiment of the present invention which serves to exemplify the various advantages and objects hereof, and are as follows:

FIG. 1 is a top view of the wireless keyboard of the present invention.

FIG. 1A is a top view showing the rightward movement of the left unit of the keyboard of the present invention.

FIG. 1B is a top view showing the leftward movement of the right unit of the keyboard of the present invention.

FIG. 2A is a perspective view showing the first step in the use of the keyboard of the present invention.

FIG. 2B is a perspective view showing the second step in the use of the keyboard of the present invention.

FIG. 2C is a perspective view showing the third step in the use of the keyboard of the present invention.

FIG. 3A is a first perspective view showing the internal structure of the keyboard of the present invention with the back cover removed.

FIG. 3B is a second perspective view showing the internal structure of the keyboard of the present invention with the back cover removed.

FIG. 3C is a third perspective view showing the internal structure of the keyboard of the present invention with the back cover removed.

FIG. 3D is a fourth perspective view showing the internal structure of the keyboard of the present invention with the back cover removed.

FIG. 4 is a flow chart schematically illustrating how the driver is installed and the wireless connection is established.

### LIST OF REFERENCE NUMERALS

1 Left unit
11 Left key module
12 Sliding member
13 Switch
14 Battery slot
15 Disengagement switch
16 Fold-up switch
151 Engagement member
152 Returning spring
2 Right unit
21 Right key module
22 Slot
23 Rack
24 Affixing member
3 Connection plate
4 Cylindrical rod
5 Distal slot
6 Proximal slot
100 Installation of the driver
101 Successfully installed?
102 Turn on the keyboard
103 If the orange LED flashes once
104 The battery needs to be replaced
105 If the green LED flashes once
106 Switch to “BTKeybd config”
107 Select “Active BTKeybd” to establish a wireless connection with the keyboard
108 The driver automatically searches for a wireless keyboard
109 Whether the wireless connection is established
110 The orange LED flashes twice
111 The battery needs to be replaced
112 The green LED flashes twice
113 Select “Reconnection” to re-establish the wireless connection
114 Set “typing repeat rate”
115 Set “typing repeat delay”
116 Test out the key-in operation in the key-in testing area
117 Set the speedy switching functions in the “BTKeybd function
118 The keyboard is ready for use

### DETAILED DESCRIPTION OF THE PREFERRED EMBODIMENT

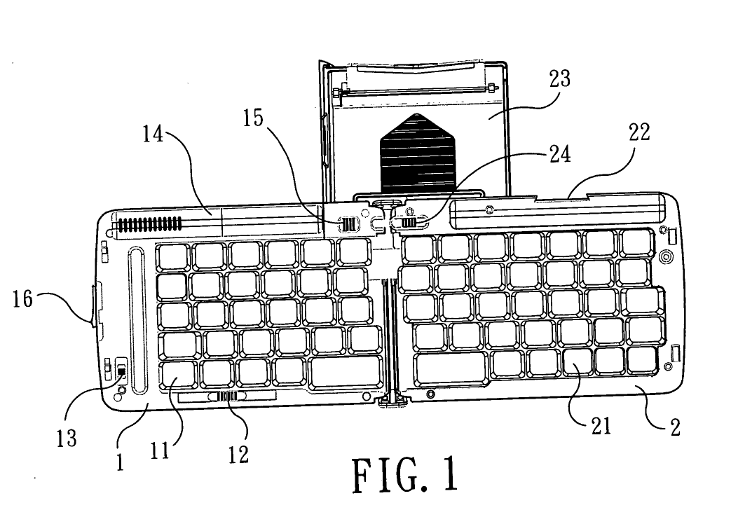

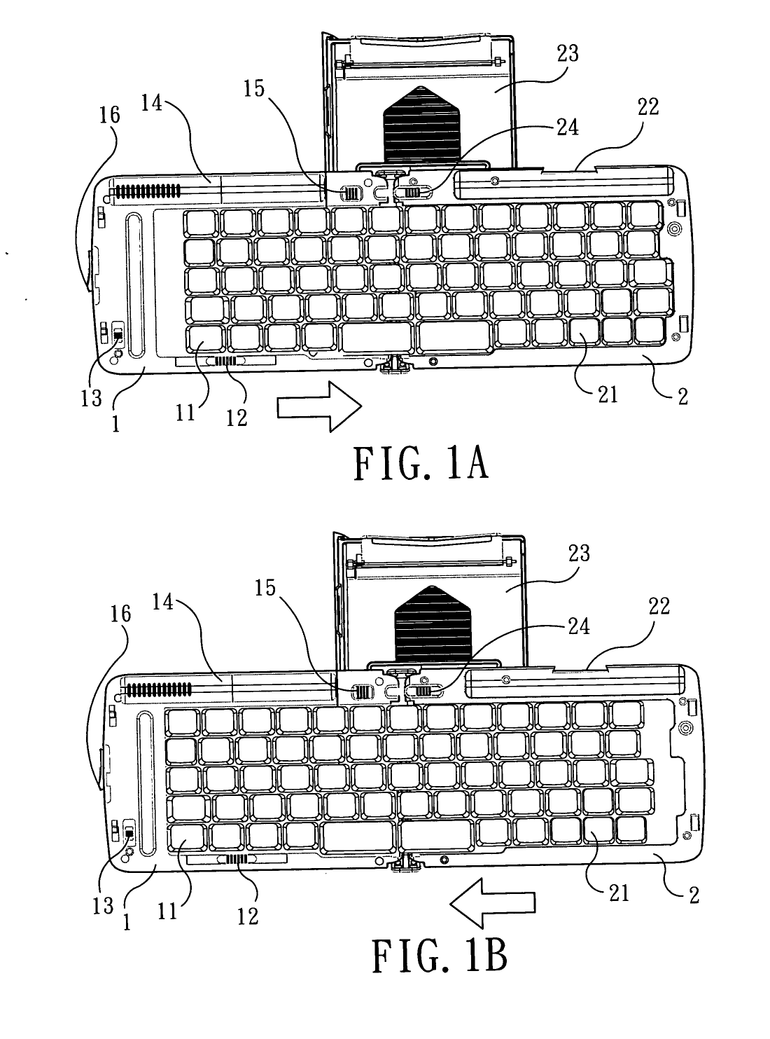

Referring to FIG. 1, 1A and 1B, the keyboard of the present invention comprises a left unit 1 and a right unit 2. The left unit 1 has a left key module 11, a sliding member 12, a switch 13, a battery slot 14, a disengagement switch 15 and a fold-up switch 16; the fold-up switch 16 is disposed on the side wall of the left unit 1. The right unit 2 has a right key module 21, a slot 22, a rack 23 and an affixing member 24. The affixing member 24 can affix the left unit 1 with the right unit 2.

A connection plate 3 is disposed between the left unit 1 and the right unit 2 and can allow the keyboard to fold.

A track is provided inside the two units 1, 2 and allows the sideway movement of the two units 1, 2 so that the two key modules 11, 21 may be joined into a complete key module.

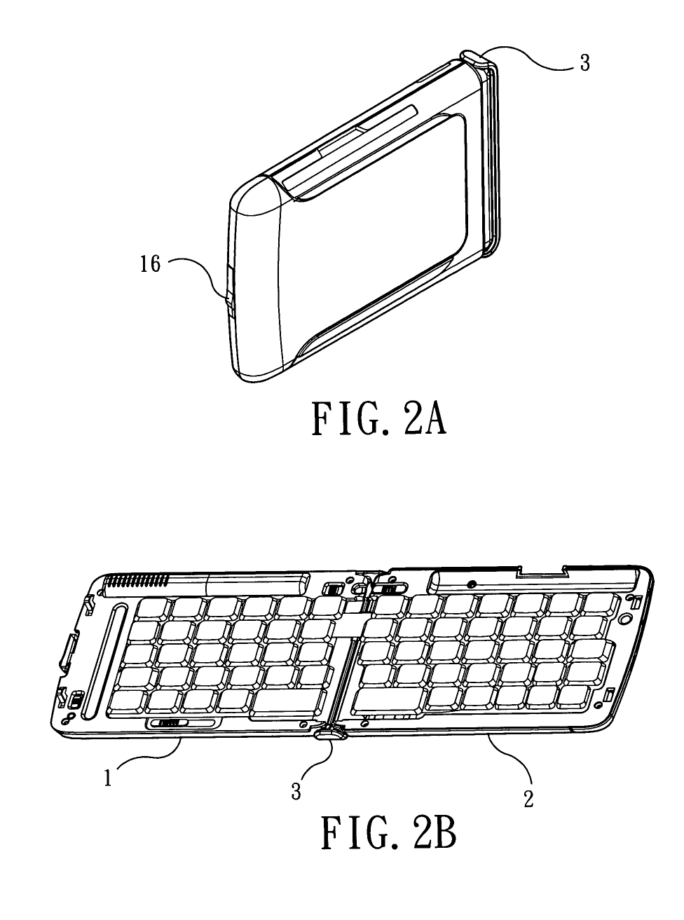

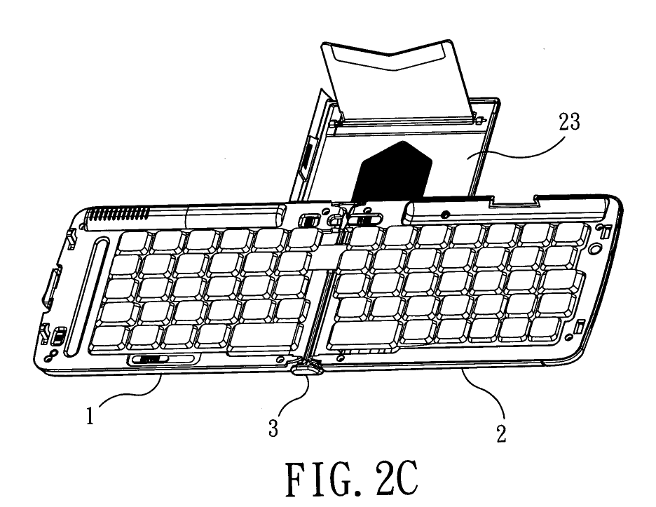

Referring to FIG. 2A to 2C, to use the keyboard, a user switches off the fold-up switch 16 and then unfolds the keyboard. Next, the user pulls out the rack 23 from the slot 22. Now, the keyboard is ready to be used.

To fold the keyboard, the user simply reverses the aforesaid procedure (in the order of FIG. 2C→FIG. 2B→FIG. 2A). First, push the rack 23 into the slot 22. Then, fold up the keyboard. Also, after the keyboard is folded, its length becomes half so that the user may carry it easily.

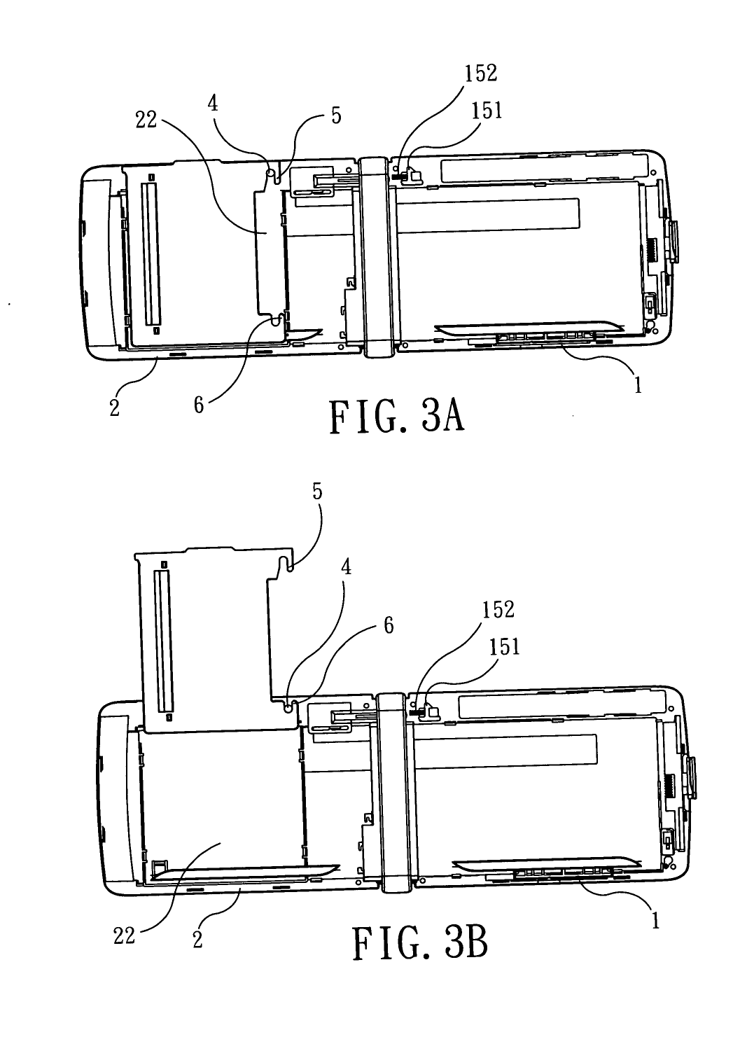

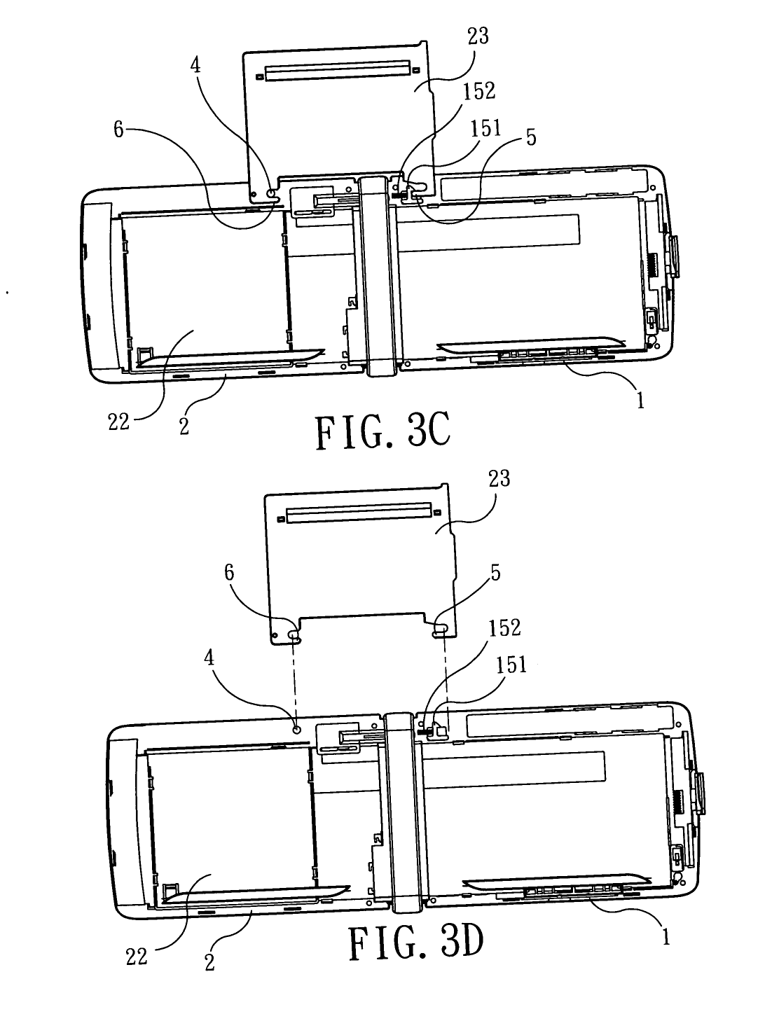

Now, please refer to FIG. 3A to 3D. In these four drawings, the back cover is removed as that the internal structure may be shown.

When the user pulls out the rack 23 from the slot 22 of the right unit 2, a proximal slot 6 provided on the rack 23 engages with a cylindrical rod 4. As-the rack 23 is moved towards the left, the distal slot 5 engages with an engagement member 151 disposed in the left unit 2 so as to affix the rack 23.

A returning spring 152 is provided by the engagement member 151.

When the user wants to retract the rack 23, first, he switches on the disengagement switch 15; now, the engagement member 151 disengages from the distal slot 5 and the returning spring 152 returns the engagement member 151 to its former position.

Alternatively, the user may pull the rack 23 completely out of the right unit 2 so that the rack 23 may be separated from the keyboard.

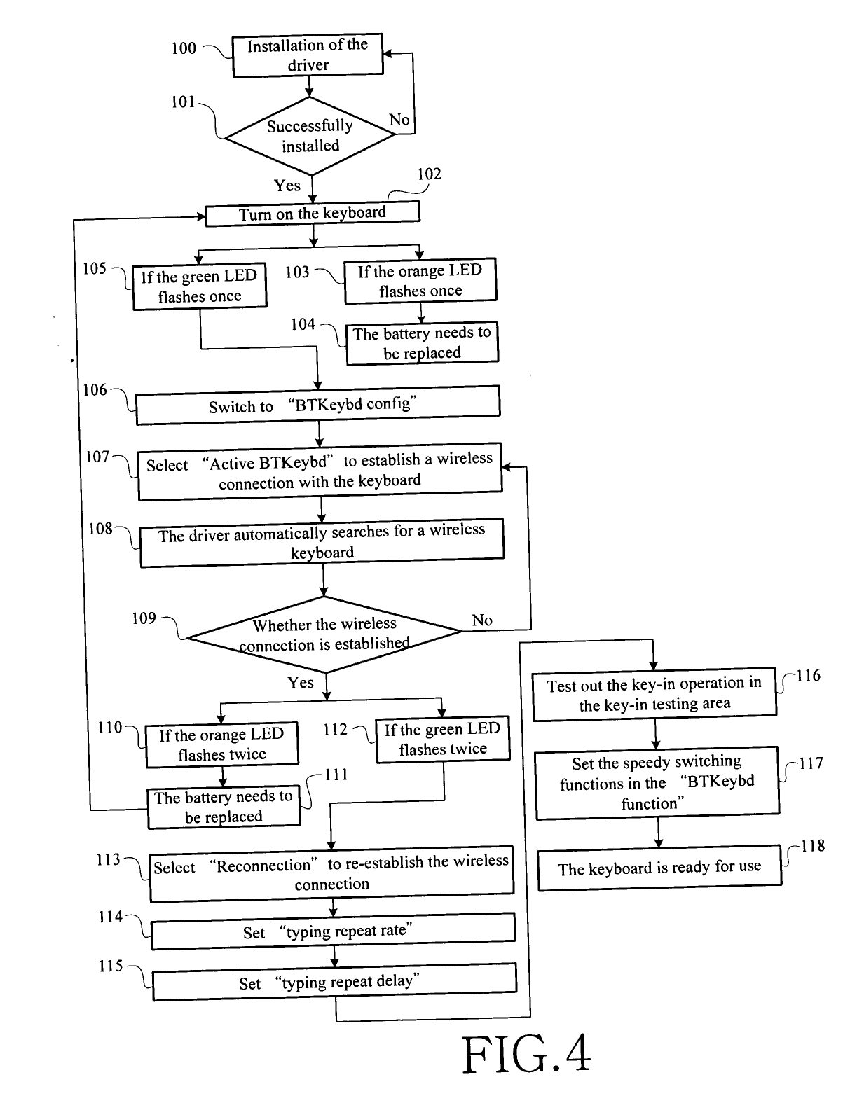

FIG. 4 is a flow chart schematically illustrating how the driver is installed and the wireless connection is established.

First, the driver 100 should be installed in a telecommunication device. If the driver 100 is not successfully installed, it should be installed again. Then, the user turns on the keyboard 102. Now, if the orange LED flashes once 103, this means the battery needs to be replaced 104. After the battery is replaced with a new one, the user may turns on the keyboard again.

Now, when the green LED flashes once 105, the user may switch to “BTKeybd config” 106 and select “Active BTKeybd” to establish the wireless connection with the keyboard 107; now, the driver automatically searches for a wireless keyboard 108. Next, the user checks whether the wireless connection is established 109. If the wireless connection is not established, select “Active BTKeybd” again.

If the wireless connection is established and the orange LED flashes twice 110, this means the battery needs to be replaced 111. After the battery is replaced with a new one, the user turns on the keyboard again 102. When the green LED flashes twice 112, the user may select “Reconnection” to re-establish the wireless connection 113. Now, the user may set “typing repeat rate” 114 and then set “typing repeat delay” 115. Then, the user may test out the key-in operation in the key-in testing area 116. Next, the user may set the speedy switching functions 117 in the “BTKeybd function”. Now, the keyboard is ready for use 118.

Many changes and modifications in the above described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A portable wireless keyboard, comprising at least a transmission end
and a reception end;
the transmission end comprising at least a body, a key module, an affixing member, a track, a rack and a wireless circuit module,
wherein the body comprises a left unit and a right unit, and the key module comprises a left key module and a right key module, the left and right key modules being disposed on the left unit and the right unit, respectively, the affixing member being disposed near the midpoint of the body and being able to affix the left unit with the right unit, a track being provided inside the left unit and the right unit so as to allow the sideway movement of the two units, a rack being disposed inside the body and being pulled out in use, the wireless circuit module being disposed inside the body so as to allow control signals to be sent out in a wireless manner;
the reception end comprising at least a driver and a telecommunication device,
wherein the driver is to be installed in the telecommunication device, the driver being able to automatically search for a transmission end and establish a wireless connection between the telecommunication device and the keyboard so that the telecommunication device may receive and respond to the control signals.

2. The portable wireless keyboard as in claim 1, wherein the affixing member may be disposed on the track so that the affixing member may automatically return to its former position when the keyboard is folded up accidentally and so that no damage is done to the left and right units.

3. The portable wireless keyboard as in claim 1, wherein the rack may be separately formed or may be integrally formed with the body.

4. The portable wireless keyboard as in claim 1, wherein the wireless circuit module may be a Bluetooth wireless circuit module.

5. The portable wireless keyboard as in claim 1, wherein the wireless circuit module may be an infrared radiation wireless circuit module.

6. The portable wireless keyboard as in claim 1, wherein the wireless circuit module may be an “IEEE 802.11b” wireless circuit module.

7. The portable wireless keyboard as in claim 1, wherein the telecommunication device may be a smart cell phone.

8. The portable wireless keyboard as in claim 1, wherein the telecommunication device may be a PDA.
